(19) United States
(12) Patent Application Publication
(10) Pub. No.: US 2009/0296251 A1
(43) Pub. Date: Dec. 3, 2009

(54) CONTROL APPARATUS, STORAGE DEVICE, AND TIMEOUT-POSSIBILITY NOTIFYING METHOD

(75) Inventors: Yuji Karakawa, Kawasaki (JP); Hidekazu Masuyama, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/350,646

(22) Filed: Jan. 8, 2009

(30) Foreign Application Priority Data
May 28, 2008 (JP) 2008-140041

(51) Int. Cl. G11B 27/36

(52) U.S. Cl. 360/31; G9B/27.052

(57) ABSTRACT

A magnetic disk device performs test write on a test cylinder to check the state of each head before system information is stored in disks. The magnetic disk device then determines the state of each head based on the test write results stored in a test-write-result table. When a head is defective, the magnetic disk device notifies a host of the possibility of the occurrence of a timeout as a fault prediction.

### CROSS-REFERENCE TO RELATED APPLICATIONS

This application is based upon and claims the benefit of priority of the prior Japanese Patent Application No. 2008-140041, filed on May 28, 2008, the entire contents of which are incorporated herein by reference.

### BACKGROUND

1. Field

The present invention relates to a control apparatus, a storage device, and a timeout-possibility notifying method for storing system information in a storage medium with a head.

2. Description of the Related Art

In general, a storage device such as a magnetic disk device stores system information in a specific area. Examples of the system information include control data for controlling the operation of the device (e.g., defect data and mode parameters) and log data indicative of previous operations (e.g., statistical information about the number of reads/writes and error details). Reference may be had to Japanese Laid-open Patent Publication No. 2006-48789. Although stored at various timings, for example, the system information is stored when an event, such as an error or receipt of Reset, occurs as is the case of log data.

For example, when an A command is issued from a host, a magnetic disk device analyzes the A command. As a result of analysis, when an error is detected in the A command, the magnetic disk device notifies the host of the error, then writes the content of the error to a medium as system information, and stores data (see FIG. 9).

At the time of storing the system information, when in a state where a write error is likely to occur (e.g., when the magnetic disk is vibrating), the magnetic disk device retries writing attempts, and thus takes more time than in a normal state.

Besides, the system information is data that influences the operation of the device and is therefore important. Accordingly, for increasing reliability, the magnetic disk device stores the same data in a multiple manner in several locations (e.g., all heads). This multiple storage can cause a time delay.

As described above, in the conventional technology, when in a state where a write error is likely to occur (e.g., when the magnetic disk is vibrating) upon storing the system information, the magnetic disk device retries writing attempts, and thus takes more time than in a normal state.

As a result, even when the host issues a command, the magnetic disk device cannot execute the command, and the host detects a timeout (see FIG. 10). That is, a timeout occurs due to a cause unknown to a host side.

### SUMMARY

It is an object of the present invention to at least partially solve the problems in the conventional technology.

According to an aspect of an embodiment, a control apparatus includes: a head test unit that performs, before system information is stored in a storage medium of a storage device, a test to check state of heads of the storage device; and a host notifying unit that notifies, when a head among the heads is determined as defective based on a result of the test by the head test unit, a host that the head is defective.

According to another aspect of an embodiment, a storage device includes: a head test unit that performs, before system information is stored in a storage medium, a test to check state of heads; and a host notifying unit that notifies, when a head among the heads is determined as defective based on a result of the test by the head test unit, a host that the head is defective.

According to still another aspect of an embodiment, a timeout-possibility notifying method includes: performing, before system information is stored in a storage medium of a storage device, a test to check state of a head of the storage device; and notifying, when the head is determined as defective based on a result of the test, a host that the head is defective.

Additional objects and advantages of the invention (embodiment) will be set forth in part in the description which follows, and in part will be obvious from the description, or may be learned by practice of the invention. The object and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

FIG. 1 is a block diagram of a magnetic disk device according to an embodiment;

FIG. 2 is a diagram of an example of a test-write-result table;

FIG. 3 is a schematic diagram for explaining a process of performing test write again by changing a cylinder;

FIG. 4 is a schematic diagram for explaining a process of sending notification to a host based on test write results;

FIG. 5 is a schematic diagram for explaining a process of storing system information in a Flash ROM;

FIG. 6 is a schematic diagram for explaining a retest write process;

FIG. 7 is a flowchart of a timeout-possibility notifying process performed by the magnetic disk device according to the embodiment;

FIG. 8 is a flowchart of a system-information storage process performed by the magnetic disk device according to the embodiment; and

FIGS. 9 and 10 are schematic diagrams for explaining a conventional technology.

### DETAILED DESCRIPTION OF THE PREFERRED EMBODIMENTS

Exemplary embodiments of the present invention are described in detail below with reference to the accompanying drawings.

Described below is the configuration of a magnetic disk device according to an embodiment and the operation thereof. Although a magnetic disk device is described below as an example of a storage device, the present invention can be applied to other storage devices than the magnetic disk device, such as a magneto-optical disk.

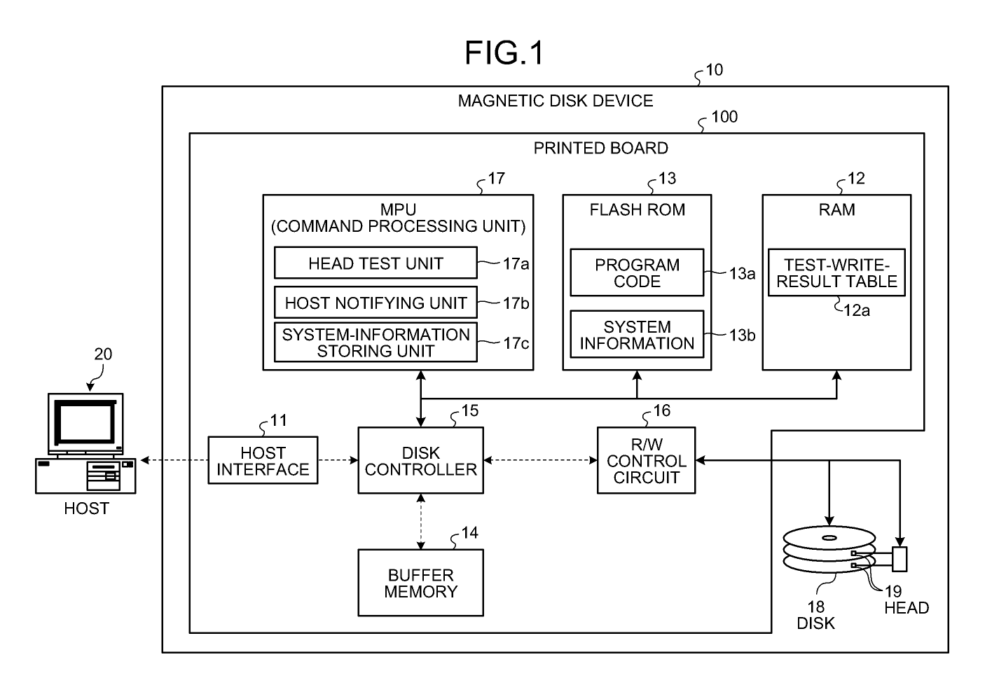

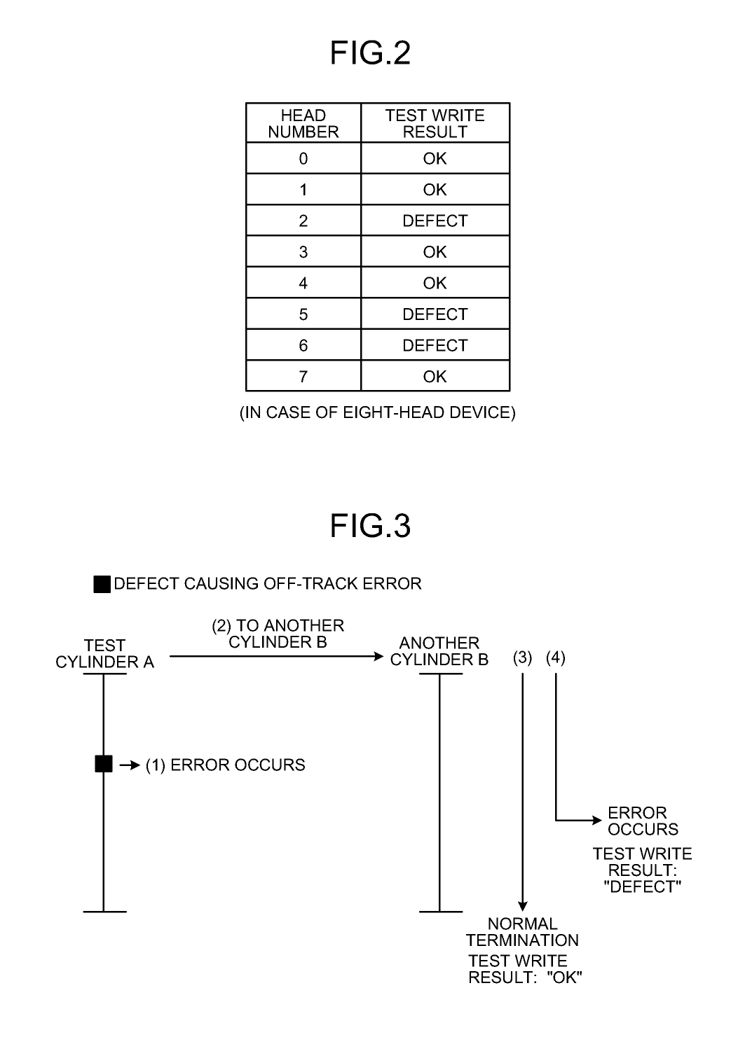

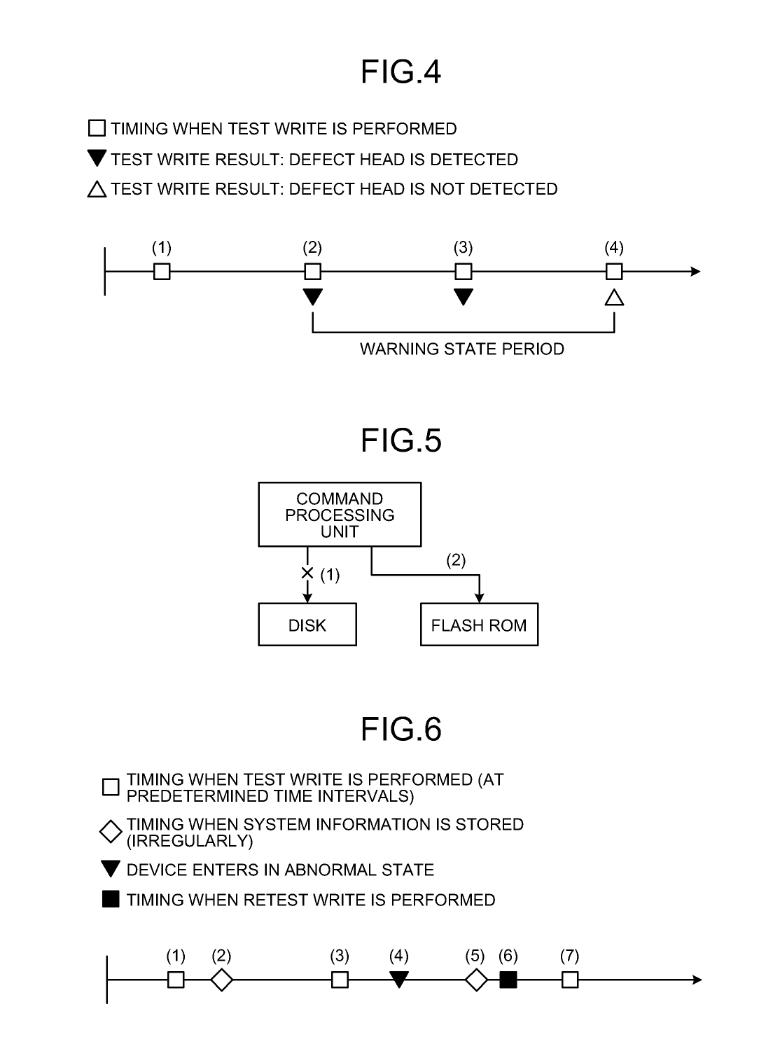

With reference to FIGS. 1 to 6, the configuration of a magnetic disk device 10 according to an embodiment is explained. FIG. 1 is a block diagram of the magnetic disk device 10. FIG. 2 is a diagram of an example of a test-write-result table. FIG. 3 is a schematic diagram for explaining a process of performing test write again by changing a cylinder. FIG. 4 is a schematic diagram for explaining a process of sending notification to a host based on test write results. FIG. 5 is a schematic diagram for explaining a process of storing system information in a Flash ROM. FIG. 6 is a schematic diagram for explaining a retest write process.

As depicted in FIG. 1, the magnetic disk device 10 includes a printed board 100, disks 18, and heads 19, and is connected to a host 20. The operation of each of these components is explained below.

The disks 18 record various data and position control information. In the disks 18, a predetermined area is set as a test cylinder. On the test cylinder, a head test unit 17a, which will be described later, performs test write, thereby checking each head.

Each of the heads 19 has incorporated therein an electrical-magnetic converting element formed of a read element and a write element, and performs reading and writing various data and position control information from and to the disks 18.

The printed board 100 has a host interface 11, a Random Access Memory (RAM) 12, a Flash Read Only Memory (ROM) 13, a buffer memory 14, a disk controller 15, a Read/Write (R/W) control circuit 16, and a Micro processing Unit (MPU) (command processing unit) 17.

The host interface 11 controls communication regarding various information exchanged with the connected host 20. Specifically, the host interface 11 receives an obtained command from the host 20, and transmits the process result, an error report, and a fault prediction to the host 20.

The RAM 12 stores a test-write-result table 12a. The test-write-result table 12a stores the results of a test performed by the head test unit 17a, which will be described later. Specifically, as exemplified in FIG. 2, the test-write-result table 12a stores “head number” that uniquely identifies each head and “test write result” representing results of test write in association with each other.

The Flash ROM 13 stores data and programs required for various processes by the MPU 17 and, in particular, stores program codes 13a and system information 13b. The program codes 13a form a program required for various processes, and are read by the MPU 17, which will be described later. The system information 13b is written by a system-information storing unit 17c, which will be described later, when it cannot write the system information to the disks 18 (details will be provided further below with reference to FIG. 5). The buffer memory 14 is a cache that temporarily stores data to be read or written between the host 20 and the disks 18.

The disk controller 15 notifies the R/W control circuit 16 of a read/write control signal based on a command reported from the host 20. The disk controller 15 stores recording information read from the disks 18 in the buffer memory 14, and then transmits the information to the host 20 via the host interface 11. The R/W control circuit 16 performs a read/write process on the disks 18 based on the read/write control signal reported from the disk controller 15.

The MPU (command processing unit) 17 has an internal memory for storing programs defining various process procedures and necessary data, and performs various processes based on these programs and data. The MPU 17 includes the head test unit 17a, a host notifying unit 17b, and the system-information storing unit 17c.

The head test unit 17a checks the state of the heads 19, i.e., checks whether the heads 19 are defective, before the system information is stored. Specifically, the head test unit 17a performs test write regularly at predetermined time intervals on a test cylinder to check the state of each head.

The head test unit 17a then determines whether an off-track error occurs. When it is determined that an off-track error has occurred, the head test unit 17a changes the cylinder as depicted in FIG. 3 to perform test write again.

That is, when test write is performed but an off-track error occurs, it is unknown whether the off-track error is caused due to a defect of the device or a problem in the tested cylinder itself. To get around this, the head test unit 17a performs test write again after changing the cylinder to check whether the cause of the off-track error is a defect of the device or a problem in the cylinder itself.

The head test unit 17a stores the test result in the test-write-result table 12a of the RAM 12. For example, when the test write normally ends, the head test unit 17a stores the test write result as being “OK”. When an error occurs, the head test unit 17a stores the test write result as being “DEFECT”.

Besides, when receiving an instruction for performing retest write from the system-information storing unit 17c, which will be described later, the head test unit 17a performs test write on a test cylinder to check the state of each head (details will be provided further below with reference to FIG. 6).

Since it should not take time to perform such test write, a timer monitors the time to prevent a timeout. Also provided is a function of suspending the test write after a predetermined time. Besides, in a test sense, conditions for the number of retries is restrictively set to be smaller than normal settings.

As a result of the test write, when it is determined that any head is defective, the host notifying unit 17b notifies the host 20 that the head is defective. Specifically, when it is determined, based on the test write results stored in the test-write-result table 12a, that a head is defective, the host notifying unit 17 notifies the host 20 that the head is defective.

For example, from the test write results stored in the test-write-result table 12a, when a head with “DEFECT” is present, the host notifying unit 17b notifies and warns the host 20 of such presence as a fault prediction.

With reference to FIG. 4, a process of sending notification to the host 20 based on the test write results is specifically explained. As depicted in FIG. 4, the magnetic disk device 10 regularly performs test write at timings (1) to (4).

When the magnetic disk device 10 performs test write at the timing (1) and finds that all heads are normal (OK) but detects a defective head at the timing (2), the magnetic disk device 10 notifies the host of a fault prediction such that a warning state starts from the timing (2).

Next, the magnetic disk device 10 performs test write at the timing (3). When a defective head is detected, the warning state continues. The magnetic disk device 10 then performs test write at the timing (4). When all heads are normal (OK), the warning state is released.

The system-information storing unit 17c uses a head in a state determined as normal based on the test write results stored in the test-write-result table 12a to store the system information. Specifically, when an event that starts or triggers a system-information storage process (e.g., an error or receipt of Reset) occurs, the system-information storing unit 17c refers to the test write results stored in the test-write-result table 12a to store the system information with a normal head.

The system-information storing unit 17c then determines whether the system information cannot be stored due to an error caused by a high incidence of retries or the like. As depicted in FIG. 5, when the system information cannot be stored due to an error caused by a high incidence of retries or the like, the system-information storing unit 17c suspends the system-information storage process, and stores the system information in the Flash ROM 13 instead of storing it in the disks 18.

That is, if the system information cannot be written, for example, an event that write is disabled cannot be left on the log. Therefore, when a faulty device is analyzed later, its cause cannot be known. To get around this, when the system information cannot be written in the disks 18, it is stored in the Flash ROM 13 so that the occurrence of such an event can be known later.

Next, after storing the system information in the Flash ROM 13 instead of storing it in the disks 18, the system-information storing unit 17c instructs the head test unit 17a to perform retest write. The head test unit 17a thereby performs test write on the test cylinder.

With reference to FIG. 6, a retest write process is explained. As depicted in FIG. 6, the magnetic disk device 10 regularly performs test write at timings (1), (3), and (7). When all heads are normal (OK) at the timing (1) and a system-information storing event occurs at a timing (2) since all heads are normal, the magnetic disk device 10 stores the system information with all heads.

Next, it is assumed that an error occurs at a timing (4) and the magnetic disk device 10 cannot write with heads 1, 3, 4, and 6. In this case, when a system-information storing event occurs at a timing (5), since the test write results indicate that all heads are normal, the magnetic disk device 10 tries to perform write of the system information with all heads.

In reality, however, the magnetic disk device 10 cannot write with the heads 1, 3, 4, and 6. Therefore, after suspending the system-information storage process due to a high incidence of retries, the magnetic disk device 10 determines that the test write results do not match the actual state of the device and starts retest write at a timing (6).

That is, when the test write results stored in the test-write-result table 12a do not match the actual state of the magnetic disk device 10, test write is performed again to update the test write results to the latest.

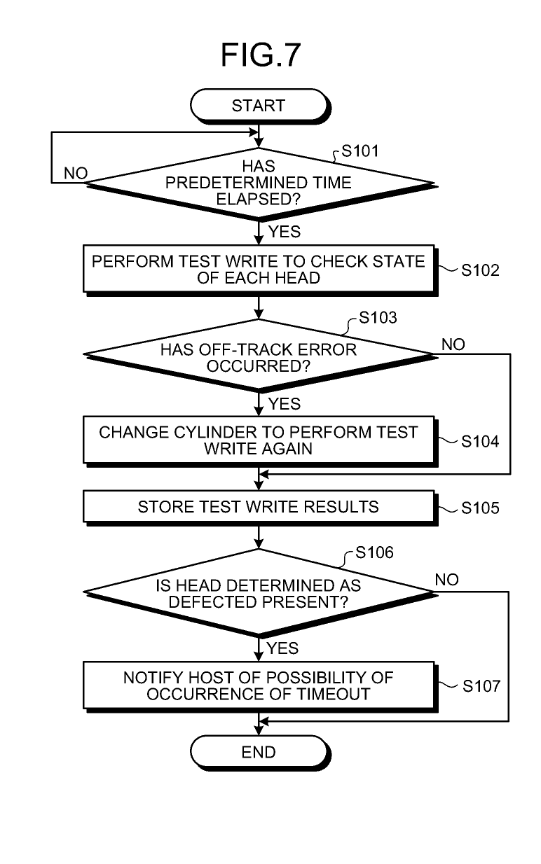

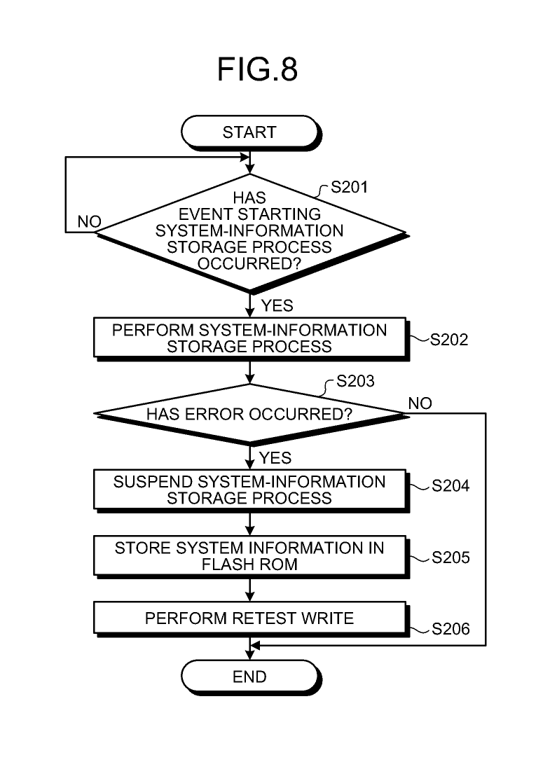

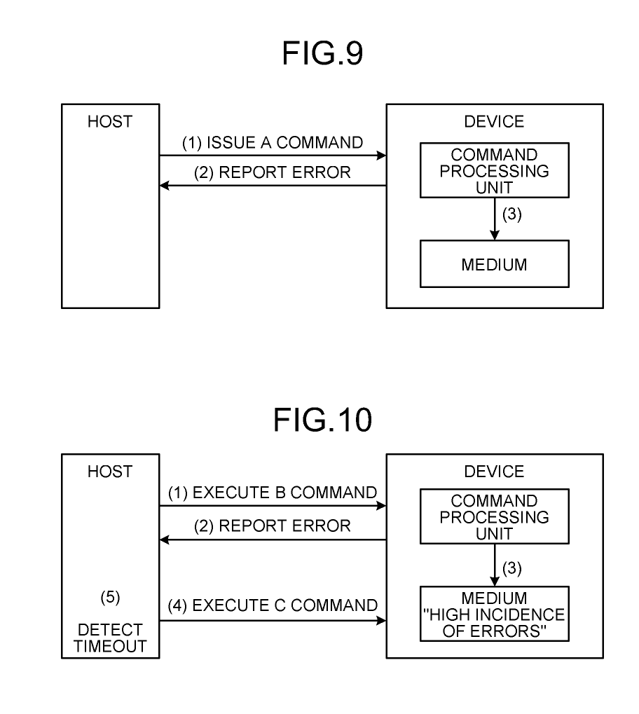

With reference to FIGS. 7 and 8, the operation of the magnetic disk device 10 according to the embodiment is explained. FIG. 7 is a flowchart of a timeout-possibility notifying process performed by the magnetic disk device 10 according to the embodiment. FIG. 8 is a flowchart of a system-information storage process performed by the magnetic disk device 10 according to the embodiment.

As depicted in FIG. 7, after a predetermined time has elapsed (Yes at Step S101), the magnetic disk device 10 performs test write on the test cylinder to check the state of each head (Step S102).

The magnetic disk device 10 then determines whether an off-track error has occurred (Step S103). When determining that an off-track error has occurred (Yes at Step S103) the magnetic disk device 10 changes the cylinder to perform test write again (Step S104), and stores the test write results in the test-write-result table 12a of the RAM 12 (Step S105).

When an off-track error has not occurred (No at Step S103), the magnetic disk device 10 does not perform test write again and stores the test write results in the test-write-result table 12a of the RAM 12 (Step S105).

The magnetic disk device 10 then determines, based on the test write results stored in the test-write-result table 12a, whether the state of each head is abnormal, i.e., whether there is any defective head (Step S106). When the state is not abnormal (No at Step S106), the process directly ends. On the other hand, when the state of any head is abnormal (Yes at Step S106), the magnetic disk device 10 notifies the host 20 of the possibility of the occurrence of a timeout as a fault prediction (Step S107).

With reference to FIG. 8, a system-information storage process performed by the magnetic disk device according to the embodiment is explained. As depicted in FIG. 8, when an event starting a system-information storage process (e.g., an error or receipt of Reset) occurs (Yes at Step S201), the magnetic disk device 10 refers to the test write results stored in the test-write-result table 12a and stores the system information with a normal head (Step S202).

The magnetic disk device 10 then determines whether an error has occurred due to a high incidence of retries or the like and therefore the system information cannot be stored (Step S203). When determining that an error has occurred due to a high incidence of retries or the like and therefore the system information cannot be stored (Yes at Step S203), the magnetic disk device 10 suspends the system-information storage process (Step S204).

The magnetic disk device 10 then stores the system information in the Flash ROM 13 instead of storing it in the disks 18 (Step S205). After storing the system information in the Flash ROM 13 instead of the disks 18, the magnetic disk device 10 performs retest write (Step S206). When it is determined at Step S203 that an error has not occurred (No at Step S203), the process ends upon the system information is stored.

As described above, according to the embodiment, before storing the system information in any of the disks 18, the magnetic disk device 10 performs a test to check the state of the heads 19 of the disks 18. When determining, based on the test results, that any of the heads 19 is defective, the magnetic disk device 10 notifies the host 20 that the relevant head 19 is defective. Thus, before the system information is stored, the state of the heads 19 is known in advance, and the host 20 is notified of the test results as a fault prediction. With this, it is possible to let the host 20 know in advance a magnetic disk in which a timeout is likely to occur. As a result, it is possible to let the host 20 side know the state of the magnetic disk device 10.

Moreover, the magnetic disk device 10 performs test write on a test cylinder, which is a predetermined area of the disks 18, to check the state of the heads 19. When an error occurs in the test write, test write is performed on another test cylinder to again check the state of the heads 19. In this manner, by performing test write again on a different cylinder, the magnetic disk device 10 can check whether the off-track error is derived from an abnormal state of the device or a problem in the cylinder. In addition, the accuracy of the fault prediction provided to the host 20 can be increased.

Furthermore, based on the results of checking the state of the heads 19, the magnetic disk device 10 uses a head 19 in a state determined as normal to store the system information in the disk 18. With this, the magnetic disk device 10 can suppress the occurrence of a timeout due to a cause unknown to the host side.

Still further, when the system information cannot be stored in the disks 18, the magnetic disk device 10 stores the system information in the Flash ROM 13 instead of storing it in the disks 18. With this, for example, when an event that write is disabled cannot be left in the disks 18 as a log, the magnetic disk device 10 can prevent such a situation as that its cause cannot be known when a faulty device is analyzed later. Still further, the magnetic disk device 10 can reliably store the system information.

Still further, when the system information cannot be stored in the disks 18, the magnetic disk device 10 checks the state of the heads 19. With this, when the test write results do not match the actual state of the magnetic disk device 10, test write is performed again, and the test write results can be updated to the latest. With this, the accuracy of the fault prediction provided to the host 20 can be increased.

Still further, the magnetic disk device 10 checks the state of the heads at predetermined time intervals. That is, test write is performed for each head between command processes. As a result, overhead due to test information write can be suppressed to the minimum.

While an embodiment of the present invention has been described and illustrated, the present invention is not limited to the embodiment but is capable of numerous rearrangements, modifications and substitutions of parts and elements.

For example, in the above embodiment, test write is described as being performed regularly at predetermined time intervals to check the state of each head. Alternatively, test write may be performed when an event that starts or triggers the system-information storage process (e.g., an error or receipt of Reset) occurs and immediately before the system-information storage process.

In this case, the magnetic disk device 10 checks the state of the heads 19 immediately after an event starting the system-information storing process occurs. Therefore, write-enable or write-disable state of the heads 19 can be accurately obtained.

The constituent elements of the magnetic disk device described above are functionally conceptual, and need not be physically configured as illustrated. In other words, the specific mode of dispersion and integration of the constituent elements is not limited to the ones illustrated in the drawings, and the constituent elements, as a whole or in part, can be divided or integrated either functionally or physically based on various types of loads or use conditions. All or any part of the processing functions performed by the device or the units can be realized by a Memory Control Unit (MCU) or a control apparatus such as a Central Processing Unit (CPU) or a Micro Processing Unit (MPU) and a program analyzed and executed by the MCU or the control apparatus, or can be realized as hardware by wired logic.

As set forth hereinabove, according to an embodiment of the present invention, it is possible to let the host side know the state of the magnetic disk device.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has (have) been described in detail, it should be understood that the various changes, substitutions, and alterations could be made hereto without departing from the spirit and scope of the invention.

What is claimed is:

1. A control apparatus comprising:
a head test unit that performs, before system information is stored in a storage medium of a storage device, a test to check state of heads of the storage device; and
a host notifying unit that notifies, when a head among the heads is determined as defective based on a result of the test by the head test unit, a host that the head is defective.

2. The control apparatus according to claim 1, wherein the head test unit checks the state of the heads by performing test write on a test cylinder, which is a predetermined area on the storage medium, and, when an error occurs in the test write, the head test unit performs test write on another test cylinder to check again the state of the heads.

3. The control apparatus according to claim 1, further comprising a system-information storing unit that stores the system information in the storage medium with, among the heads, a head in a state determined as normal based on the result of the test.

4. The control apparatus according to claim 3, wherein when the system information cannot be stored in the storage medium, the system-information storing unit stores the system information in a memory.

5. The control apparatus according to claim 3, wherein when the system-information storing unit cannot store the system information in the storage medium, the head test unit checks the state of the heads.

6. A storage device comprising:
a head test unit that performs, before system information is stored in a storage medium, a test to check state of heads; and
a host notifying unit that notifies, when a head among the heads is determined as defective based on a result of the test by the head test unit, a host that the head is defective.

7. A timeout-possibility notifying method comprising:
performing, before system information is stored in a storage medium of a storage device, a test to check state of a head of the storage device; and
notifying, when the head is determined as defective based on a result of the test, a host that the head is defective.
